(19) United States
(12) Patent Application Publication
(10) Pub. No.: US 2015/0346579 A1
(43) Pub. Date: Dec. 3, 2015

(54) WAVELENGTH CONVERSION MODULE AND ILLUMINATION SYSTEM

(71) Applicants: Chi-Tang Hsieh, Hsin-Chu (TW); Jo-Han Hsu, Hsin-Chu (TW)

(72) Inventors: Chi-Tang Hsieh, Hsin-Chu (TW); Jo-Han Hsu, Hsin-Chu (TW)

(73) Assignee: Coretronic Corporation, Hsin-Chu (TW)

(21) Appl. No.: 14/631,855

(22) Filed: Feb. 26, 2015

(30) Foreign Application Priority Data
May 30, 2014 (TW) 103119011

(51) Int. Cl. G02F 1/35; F21K 99/00; F21V 7/04

(52) U.S. Cl. CPC G02F 1/353; F21V 7/04; F21K 9/56; F21Y 2101/025

(57) ABSTRACT

A wavelength conversion module that includes a reflective substrate, a strip-shaped wavelength conversion layer, and a microstructure layer is provided. The strip-shaped wavelength conversion layer is located on the reflective substrate and includes a transparent base and a wavelength conversion material doped in the transparent base. The microstructure layer is located on the strip-shaped wavelength conversion layer and includes a plurality of microstructures. The microstructures are arranged on a surface of the microstructure layer in a close-packing manner. The wavelength conversion module satisfies n2−0.3≦n1≦n2+0.3, where n1 is a refractive index of the transparent base, and n2 is a refractive index of the microstructure layer. An illumination system is also provided.

### CROSS-REFERENCE TO RELATED APPLICATION

This application claims the priority benefit of Taiwan application serial no. 103119011, filed on May 30, 2014. The entirety of the above-mentioned patent application is hereby incorporated by reference herein and made a part of this specification.

### BACKGROUND

1. Field of the Disclosure

The invention relates to an optical module and an optical system; more particularly, the invention relates to a wavelength conversion module and an illumination system.

2. Description of Related Art

In recent years, development of solid-state illumination light sources including light emitting diodes (LEDs) and laser diodes has been flourishing, and thus these solid-state illumination light sources have been acting as lighting devices in various electronic apparatuses to replace the conventional light sources, such as mercury lamps, fluorescent lamps, and so on. Compared to the conventional light sources, the solid-state illumination light sources have advantages of high light emitting efficiency, small volume, high color saturation, absence of mercury, etc.

In a projection system, the solid-state light source has also been introduced as the illumination light source. The technology that allows the light source (e.g., the LED or the laser diode) in a projection apparatus to evenly project beams with three primary colors (red, blue, and green) may be categorized into two types. One is to employ the solid-state light source to project a white beam that passes through a color wheel having red, blue, and green color filters, so as to individually generate corresponding red, blue, and green timing beams and output the mixed beams. The other is to employ the solid-state light source to emit a blue excitation beam, so as to excite the phosphor coated onto a rotary wheel and thereby generate red, blue, and green beams or yellow beams and output the mixed beams.

Japan patent publication no. H07-37511 discloses that a lumpy structure is additionally configured on a surface of a partitioning wall of a plasma display panel. Japan patent publication no. 2005-277331 discloses that a phosphor layer is coated onto an inner side of a concave reflective opening structure, so as to enhance the utilization efficiency of the beams generated by exciting the phosphor layer. China patent no. 101936505 discloses a phosphor wheel of which a reflective surface is coated with a phosphor layer. China patent No. 102073115A discloses a reflective phosphor color wheel. China patent no. 2032238620 discloses an LED illumination apparatus having optical films with microstructures. China patent no. 101651177B discloses an LED lamp packaged by two layers of encapsulants.

The information disclosed in this section “Description of Related Art” is only for enhancement of understanding of the background of the described technology and therefore it may contain information that does not form the prior art that is already known to a person of ordinary skill in the art. Further, the information disclosed in the section “Description of Related Art” does not mean that one or more problems to be resolved by one or more embodiments of the invention was acknowledged by a person of ordinary skill in the art.

### SUMMARY OF THE DISCLOSURE

The invention is directed to a wavelength conversion module capable of achieving favorable light-collecting effects.

The invention is also directed to an illumination system having favorable light utilization efficiency.

Additional aspects and/or advantages of the invention will be set forth in part in the description which follows and, in part, will be obvious from the description, or may be learned by practice of the invention.

To achieve one of, a part of or all of the above-mentioned objectives, or to achieve other objectives, an embodiment of the invention provides a wavelength conversion module that includes a reflective substrate, a strip-shaped wavelength conversion layer, and a microstructure layer. The strip-shaped wavelength conversion layer is located on the reflective substrate and includes a transparent base and a wavelength conversion material doped in the transparent base. The microstructure layer is located on the strip-shaped wavelength conversion layer and includes a plurality of microstructures. The microstructures are arranged on a surface of the microstructure layer in a close-packing manner. The wavelength conversion module satisfies n2−0.3≦n1≦n2+0.3, where n1 is a refractive index of the transparent base, and n2 is a refractive index of the microstructure layer. The close-packing manner may mean stacked in form of a layer in the hexagonal close packing.

An embodiment of the invention provides an illumination system that includes the wavelength conversion module and an excitation light source. The excitation light source is configured to emit an excitation beam, and the excitation beam coming from the excitation light source is transmitted to the strip-shaped wavelength conversion layer through the microstructure layer.

According to an embodiment of the invention, each of the microstructures satisfies P/4≦h≦P/2, h is a height of the microstructure in a direction perpendicular to the reflective substrate, and P is a pitch of the microstructures in a direction parallel to the reflective substrate.

According to an embodiment of the invention, the strip-shaped wavelength conversion layer is a ring-shaped wavelength conversion layer.

According to an embodiment of the invention, the wavelength conversion material is a fluorescent material.

According to an embodiment of the invention, the wavelength conversion module further includes a reflective cup located on the reflective substrate, and the ring-shaped wavelength conversion layer is located in the reflective cup.

According to an embodiment of the invention, the reflective cup includes a first ring-shaped reflective structure and a second ring-shaped reflective structure. The first ring-shaped reflective structure is located on an inner side of the ring-shaped wavelength conversion layer, and the second ring-shaped reflective structure is located on an outer side of the ring-shaped wavelength conversion layer.

According to an embodiment of the invention, the first ring-shaped reflective structure has a first reflective surface. The first reflective surface tilts with respect to the reflective substrate and faces the outer side of the ring-shaped wavelength conversion layer. The second ring-shaped reflective structure has a second reflective surface. The second reflective surface tilts with respect to the reflective substrate and faces the inner side of the ring-shaped wavelength conversion layer.

According to an embodiment of the invention, the wavelength conversion module further includes an actuator configured to rotate the reflective substrate.

According to an embodiment of the invention, when the reflective substrate is rotated, different regions on the strip-shaped wavelength conversion layer enter an irradiation range of the excitation beam at different times.

According to an embodiment of the invention, the microstructure layer and the transparent base are integrally formed.

According to an embodiment of the invention, the microstructures are located on a surface of the microstructure layer facing away from the strip-shaped wavelength conversion layer, and the microstructures include partially-spherical shape, arc-shaped concave surfaces, pyramidal, tetrahedron shape, or a combination thereof.

According to an embodiment of the invention, the excitation light source is a laser light source.

In view of the above, the microstructure layer in the wavelength conversion module and the illumination system described herein is located on the strip-shaped wavelength conversion layer, and the microstructures are arranged on the surface of the microstructure layer in a close-packing manner. Therefore, beams coming from the strip-shaped wavelength conversion layer are less likely to be totally reflected and more likely to be emitted from the wavelength conversion module, and the divergence angle at which the beams emitted from the wavelength conversion module may be reduced by the microstructures. Thereby, the wavelength conversion module is able to accomplish favorable light-collecting effects, and the illumination system having the wavelength conversion module can have satisfactory light utilization efficiency.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view illustrating an illumination system according to an embodiment of the invention.

FIG. 1B is a front view illustrating a wavelength conversion module depicted in FIG. 1A.

FIG. 1C is a cross-sectional view illustrating a wavelength conversion module depicted in FIG. 1A.

FIG. 1D is a partial front view of the microstructure layer depicted in FIG. 1B.

FIG. 2A shows distribution of light emitting intensity of the wavelength conversion module depicted in FIG. 1A after the microstructure layer is removed.

FIG. 2B shows distribution of light emitting intensity of the wavelength conversion module depicted in FIG. 1A.

FIG. 3A is a schematic view illustrating a wavelength conversion module according to another embodiment of the invention.

FIG. 3B is a front view illustrating a wavelength conversion module depicted in FIG. 3A.

FIG. 4 is a schematic cross-sectional view illustrating a wavelength conversion module according to yet another embodiment of the invention.

FIG. 5 is a schematic cross-sectional view illustrating a wavelength conversion module according to yet another embodiment of the invention.

FIG. 6 is a schematic cross-sectional view illustrating a wavelength conversion module according to yet another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention could be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

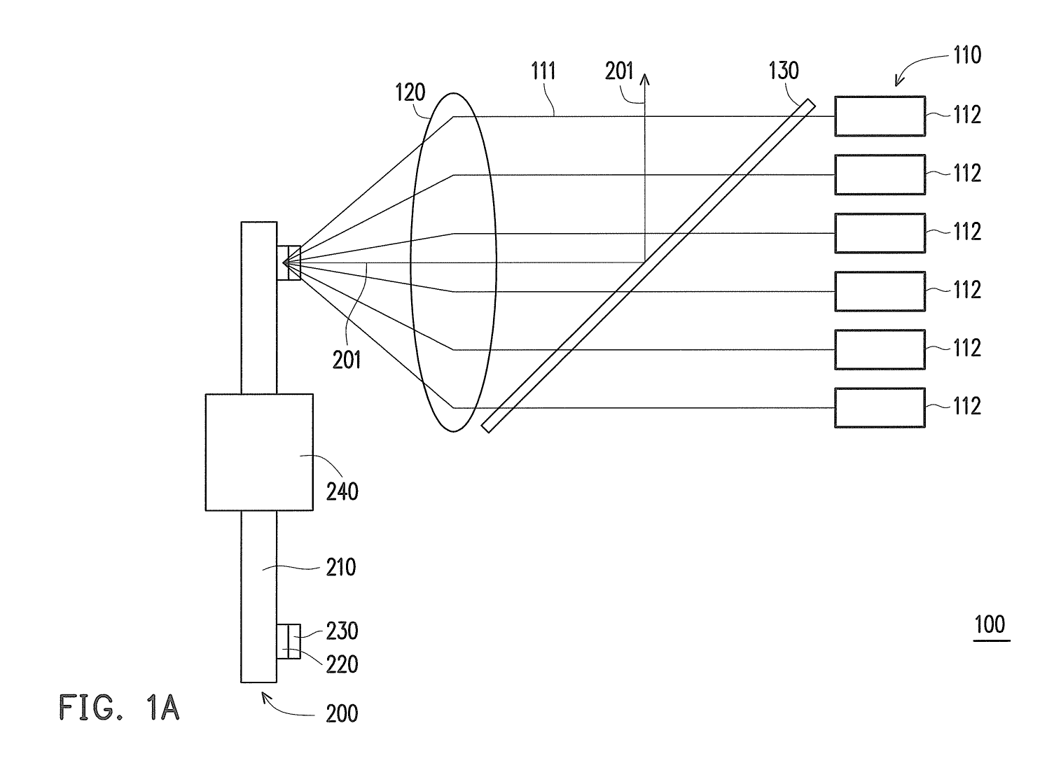

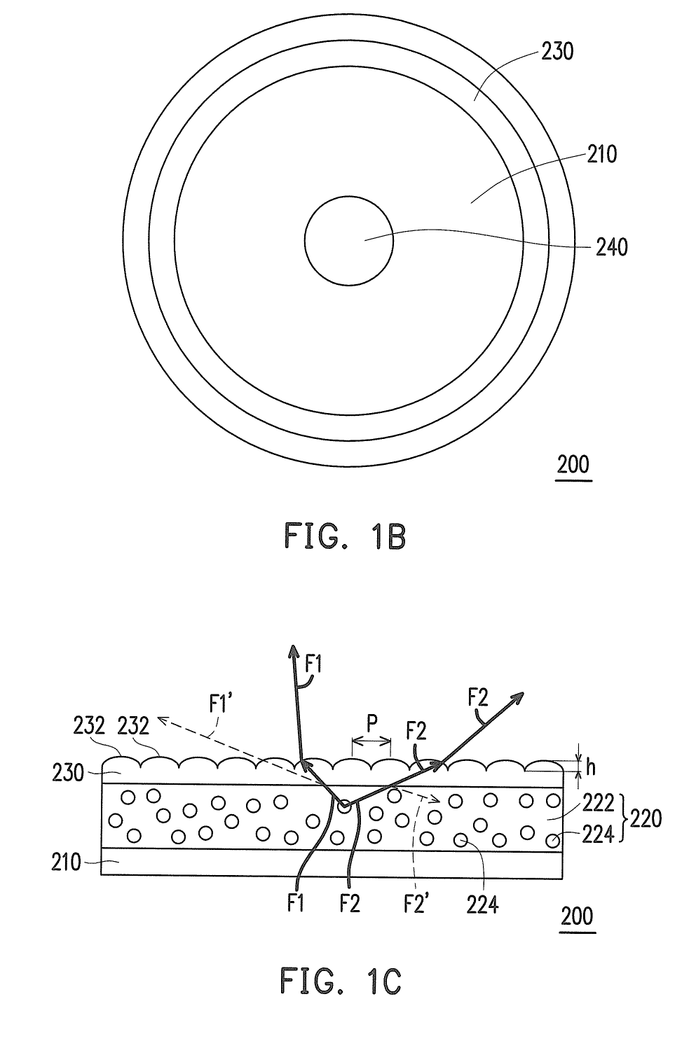

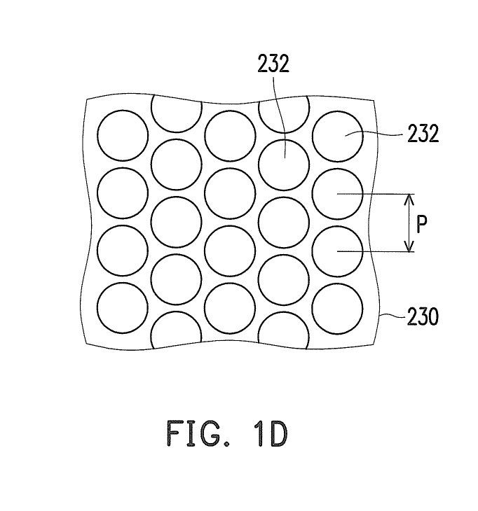

FIG. 1A is a schematic view illustrating an illumination system according to an embodiment of the invention. FIG. 1B is a front view illustrating a wavelength conversion module depicted in FIG. 1A. FIG. 1C is a cross-sectional view illustrating a wavelength conversion module depicted in FIG. 1A. FIG. 1D is a partial front view of the microstructure layer depicted in FIG. 1B. With reference to FIG. 1A to FIG. 1D, the illumination system 100 described in the embodiment includes a wavelength conversion module 200 and an excitation light source 110, and the wavelength conversion module 200 includes a reflective substrate 210, a strip-shaped wavelength conversion layer 220, and a microstructure layer 230. The strip-shaped wavelength conversion layer 220 is located on the reflective substrate 210 and includes a transparent base 222 and a wavelength conversion material 224 doped in the transparent base 222. In the embodiment, the reflective substrate 210 is, for instance, a metal substrate, and a surface of the metal substrate facing the transparent base 220 is transformed into a reflective surface after undergoing a surface polishing treatment. In another embodiment of the invention, the surface may be coated with a reflective film, so as to be transformed into the reflective surface. According to an embodiment of the invention, a material of the metal substrate is, for instance, aluminum, and a material of the reflective film is, for instance, silver. Besides, the transparent base 222 described in the embodiment is made of a transparent adhesive, e.g., an adhesive with the refractive index of 1.5, and the wavelength conversion material 224 is a fluorescent material, for instance, phosphor.

The microstructure layer 230 is located on the strip-shaped wavelength conversion layer 220 and includes a plurality of microstructures 232. The microstructures 232 are arranged on a surface of the microstructure layer 230 in a close-packing manner, e.g., stacked in form of a layer in the hexagonal close packing, as shown in FIG. 1D. In the embodiment, the microstructures 232 are located on a surface of the microstructure layer 230 facing away from the strip-shaped wavelength conversion layer 220, as shown in FIG. 1C. The microstructures 232 include partially-spherical shape, arc-shaped concave surfaces, pyramidal, tetrahedron, or a combination thereof, and the microstructures 232 with partially-spherical shape include but are not limited to semi-spherical shape or quarter-spherical shape. As shown in FIG. 1C and FIG. 1D, the microstructures 232 are partially-spherical shape (shaped as lenses), for instance.

The wavelength conversion module 200 satisfies n2−0.3≦n1≦n2+0.3, wherein n1 is a refractive index of the transparent base 222, and n2 is a refractive index of the microstructure layer 230. That is, the refractive index of the microstructure layer 230 is appropriately closes to or the same as that of the transparent base 222, such that beams transmitted from the transparent base 222 to the microstructure layer 230 are less likely to be reflected by the interface between the transparent base 222 and the microstructure layer 230. According to the embodiment, 1.3≦n1≦1.6, and 1.3≦n2≦1.6; in another embodiment of the invention, 1.0≦n1≦1.9.

The excitation light source 110 serves to provide an excitation beam 111. In the embodiment, the excitation light source 110 is a laser light source, and the excitation beam 111 is a laser beam. For instance, the excitation light source 110 may include a plurality of laser diodes 112 arranged in an array. Besides, the lens 120 converges the excitation beam 111 onto the strip-shaped wavelength conversion layer 220. The excitation beam 111 coming from the excitation light source 110 is transmitted to the strip-shaped wavelength conversion layer 220 through the microstructure layer 230. Specifically, the excitation beam 111 coming from the lens 120 is transmitted to the strip-shaped wavelength conversion layer 220 through the microstructure layer 230.

After the wavelength conversion material 224 in the strip-shaped wavelength conversion layer 220 is excited by the excitation beam 111, the excitation beam 111 is converted into a conversion beam 201. Here, the wavelength of the conversion beam 201 is greater than the wavelength of the excitation beam 111. Some parts of the conversion beam 201 emitted from the wavelength conversion material 224 are transmitted toward the microstructure layer 230 and pass through the microstructure layer 230; other parts of the conversion beam 201 emitted from the wavelength conversion material 224 are transmitted toward the reflective substrate 210 and, after being reflected by the reflective substrate 210, sequentially pass through the strip-shaped wavelength conversion layer 220 and the microstructure layer 230. The excitation beam 111 not converted by the wavelength conversion material 224 is transmitted to and reflected by the reflective substrate 210; after such reflection, the wavelength conversion material 224 is excited, or the excitation beam 111 directly passes through the transparent base 222 and the microstructure layer 230 in sequence.

For instance, if the excitation beam 111 is a blue beam, and the conversion beam 210 is a yellow beam (i.e., the wavelength conversion material 224 is yellow phosphor), the conversion beam 201 emitted from the microstructure layer 230 and the excitation beam 111 may be mixed to generate a white beam. Additionally, the excitation beam 111 coming from the excitation light source 110 may be guided by a light-splitting unit 130 to the lens 120, and the conversion beam 201 coming from the wavelength conversion module 220 and the excitation beam 111 may be collected by the lens 120 and then guided by the light-splitting unit 130 to a direction deflecting from the excitation light source 110. The light-splitting unit 130 may be a transflective device, a color-splitting device, a polarization device, or any other device capable of splitting beams.

The microstructure layer 230 in the wavelength conversion module 200 and the illumination system 100 described in the embodiment is located on the strip-shaped wavelength conversion layer 220, and the microstructures 230 are arranged on the surface of the microstructure layer 230 in a close-packing manner. Therefore, beams coming from the strip-shaped wavelength conversion layer 220 are less likely to be totally reflected and more likely to be emitted from the wavelength conversion module 200, and the divergence angle at which the beams emitted from the wavelength conversion module 200 may be reduced by the microstructures 230. Thereby, the wavelength conversion module 200 is able to accomplish favorable light-collecting effects, and the illumination system 100 having the wavelength conversion module 200 can have satisfactory light utilization efficiency.

For instance, as shown in FIG. 1C, the conversion beam F1 emitted from the wavelength conversion material 224 enters the interface between the transparent base 222 and the microstructure layer 230 (i.e., the light exit surface of the transparent base 222) at a large incident angle. In case that no microstructure layer 230 is formed on the transparent base 222, the conversion beam F1 is transmitted along a transmission path (depicted by dash lines) of the conversion beam F1′. At this time, the included angle between the direction in which the conversion beam F1′ is emitted and the normal direction of the strip-shaped wavelength conversion layer 220 is excessively large, such that the conversion beam F1′ cannot be collected by the lens 120 and cannot be utilized, which leads to light loss. By contrast, if the microstructure layer 230 is located on the transparent base 222, the conversion beam F1 moves along the path shown by a solid line; that is, the conversion beam F1 is guided by the microstructures 232 toward a direction less deflecting from the normal direction. In this case, the conversion beam F1 can still be collected by the lens 120, thus enhancing the light utilization efficiency.

If the conversion beam F2 emitted from the wavelength conversion material 224 enters the light exit surface of the transparent base 222 at a relatively large incident angle, and if no microstructure layer 230 is formed on the transparent base 222, the conversion beam F2 is transmitted along a path of the conversion beam F2′ depicted by dash lines, i.e., the conversion beam F2 is totally reflected by the light exit surface of the transparent base 222. This is because the refractive index of the transparent base 222 is greater than that of air, and the critical angle is thus smaller than the incident angle of the conversion beam F2. Accordingly, the conversion beam FT cannot be extracted from the strip-shaped wavelength conversion 220 and thus cannot be effectively utilized, which leads to light loss. By contrast, if the microstructure layer 230 is located on the transparent base 222, the conversion beam F2 moves along the path shown by a solid line; that is, the conversion beam F2 enters the microstructure layer 230 from the strip-shaped wavelength conversion layer 220, and the conversion beam F2 is guided by the microstructures 232 toward a direction less deflecting from the normal direction and is then emitted. In this case, the conversion beam F2 can still be collected by the lens 120, thus enhancing the light extraction and utilization efficiency.

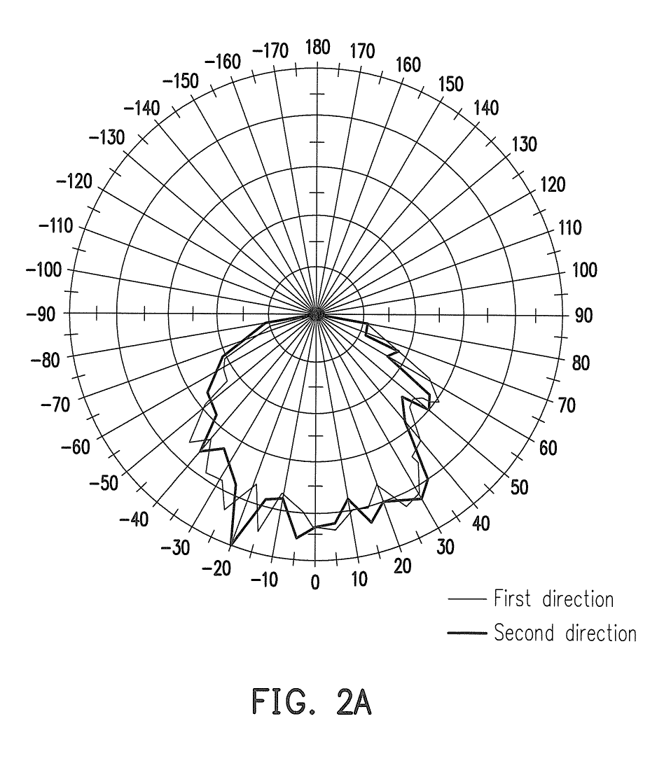

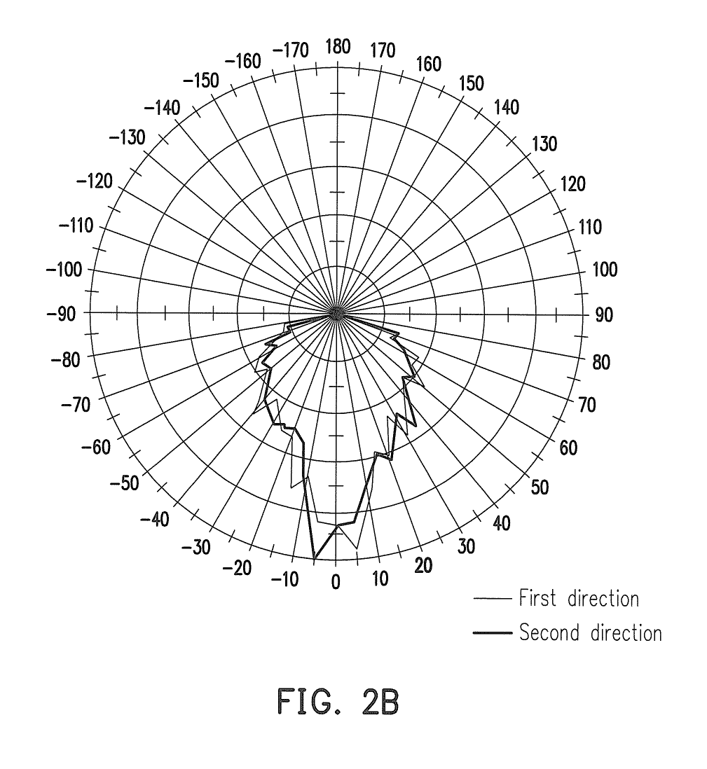

The favorable light-collecting effects and light extraction efficiency of the wavelength conversion module 200 and the exceptional light utilization efficiency of the illumination system 100 are theoretically explained above with reference to FIG. 1C and will be further proven by experiments with reference to FIG. 2A and FIG. 2B.

FIG. 2A shows distribution of light emitting intensity of the wavelength conversion module depicted in FIG. 1A after the microstructure layer is removed. FIG. 2B shows distribution of light emitting intensity of the wavelength conversion module depicted in FIG. 1A. With reference to FIG. 1A, FIG. 2A, and FIG. 2B, FIG. 2A and FIG. 2B both show distribution of the light emitting intensity at different light emitting angles. Here, the 0-degree direction is the front direction of the wavelength conversion module, and the 0-degree direction is the normal direction of the strip-shaped wavelength conversion layer 220. Besides, the data of light intensity are measured in two perpendicular directions (i.e., the first direction and the second direction). According to comparison results of the experimental data shown in FIG. 2A and FIG. 2B, the wavelength conversion module 200 described herein has the microstructure layer 230 and thus can achieve the favorable light-collecting effects, and thereby the illumination system 100 having the wavelength conversion module 200 can have satisfactory light utilization efficiency.

With reference to FIG. 1A to FIG. 1D, in the embodiment, the strip-shaped wavelength conversion layer 220 is a ring-shaped wavelength conversion layer, and the reflective substrate 210 is shaped as a disc. Besides, according to the embodiment, the wavelength conversion module 200 further includes an actuator 240 configured to rotate the reflective substrate 210. The actuator 240 described in the embodiment is, for instance, a motor connected to the reflective substrate 210 (e.g., embedded into the center of the reflective substrate 210). When the reflective substrate 210 is rotated, different regions on the strip-shaped wavelength conversion layer 230 enter an irradiation range of the excitation beam 111 at different times. Thereby, the excitation beam 111 does not continuously irradiate the same region on the strip-shaped wavelength conversion layer 230, so as to prevent the strip-shaped wavelength conversion layer 230 from receiving excessive energy and being damaged or having the reduced light conversion efficiency.

The illumination system 100 described herein may serve as the illumination system of a projection apparatus, so as to provide the illumination beam generated by mixing the excitation beam 111 and the conversion beam 201 to illuminate the light valve or provide the conversion beam 201 as the illumination beam. Besides, the strip-shaped wavelength conversion layer 230 described in the embodiment is not limited to be made of the phosphor in one single color; instead, the strip-shaped wavelength conversion layer 230 may be made of phosphors in different colors (e.g., red, green, and blue, or red, green, blue, and yellow) at different sections; in response to the rotation of the wavelength conversion module 200, beams with different colors are generated in timing.

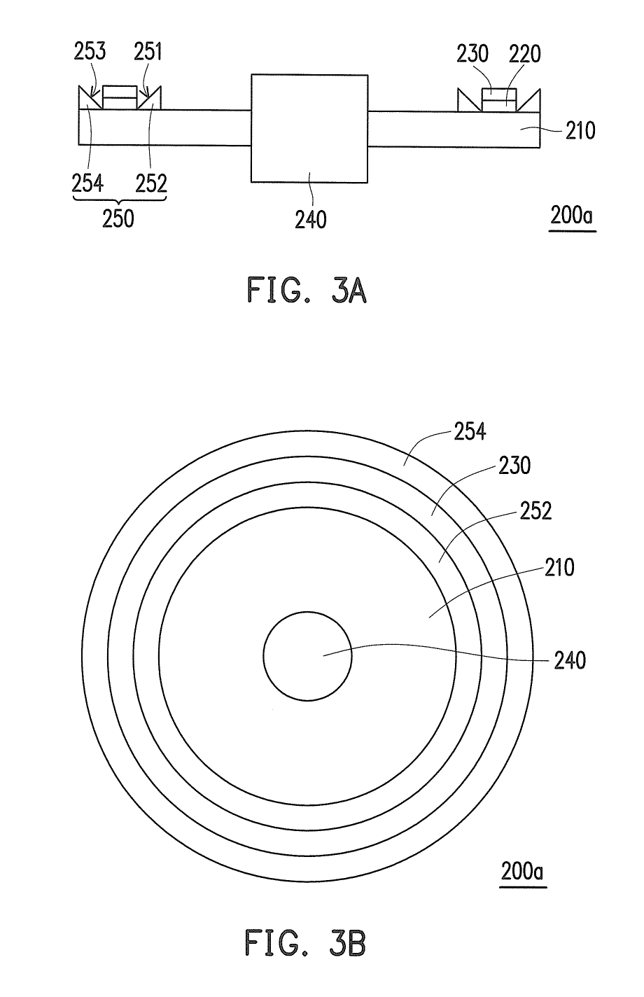

In the embodiment, each of the microstructures 232 satisfies P/4≦h≦P/2, h is a height of the microstructure 232 in a direction perpendicular to the reflective substrate 210, and P is a pitch of the microstructures 232 in a direction parallel to the reflective substrate 210. The microstructures 232 are arranged in a close-packing manner, and each of the microstructures 232 satisfies P/4≦h≦P/2, such that the wavelength conversion module 200 can have favorable light extraction efficiency and achieve satisfactory light-collecting effects. FIG. 3A is a schematic view illustrating a wavelength conversion module according to another embodiment of the invention. FIG. 3B is a front view illustrating a wavelength conversion module depicted in FIG. 3A. With reference to FIG. 3A and FIG. 3B, the wavelength conversion module 200a provided in the embodiment is similar to the wavelength conversion module 200 depicted in FIG. 1A, and the difference therebetween is described below. According to the embodiment, the wavelength conversion module 200a further includes a reflective cup 250 located on the reflective substrate 210, and the strip-shaped wavelength conversion layer 220 is located in the reflective cup 250. The reflective cup 250 described herein includes a first ring-shaped reflective structure 252 and a second ring-shaped reflective structure 254. The first ring-shaped reflective structure 252 is located on an inner side of the ring-shaped wavelength conversion layer 220, and the second ring-shaped reflective structure 254 is located on an outer side of the ring-shaped wavelength conversion layer 220.

According to the embodiment of the invention, the first ring-shaped reflective structure 252 has a first reflective surface 251. The first reflective surface 251 tilts with respect to the reflective substrate 210 and faces the outer side of the strip-shaped wavelength conversion layer 220 (i.e., the ring-shaped wavelength conversion layer). The second ring-shaped reflective structure 254 has a second reflective surface 253. The second reflective surface 253 tilts with respect to the reflective substrate 210 and faces the inner side of the strip-shaped wavelength conversion layer 220. Parts of the conversion beam 201 from the strip-shaped wavelength conversion layer 220 may escape from the side of the strip-shaped wavelength conversion layer 220, and the escaped parts of the conversion beam 201 may be reflected by the first reflective surface 251 and the second reflective surface 253 to the front of the wavelength conversion module 200a, so as to improve the light utilization efficiency.

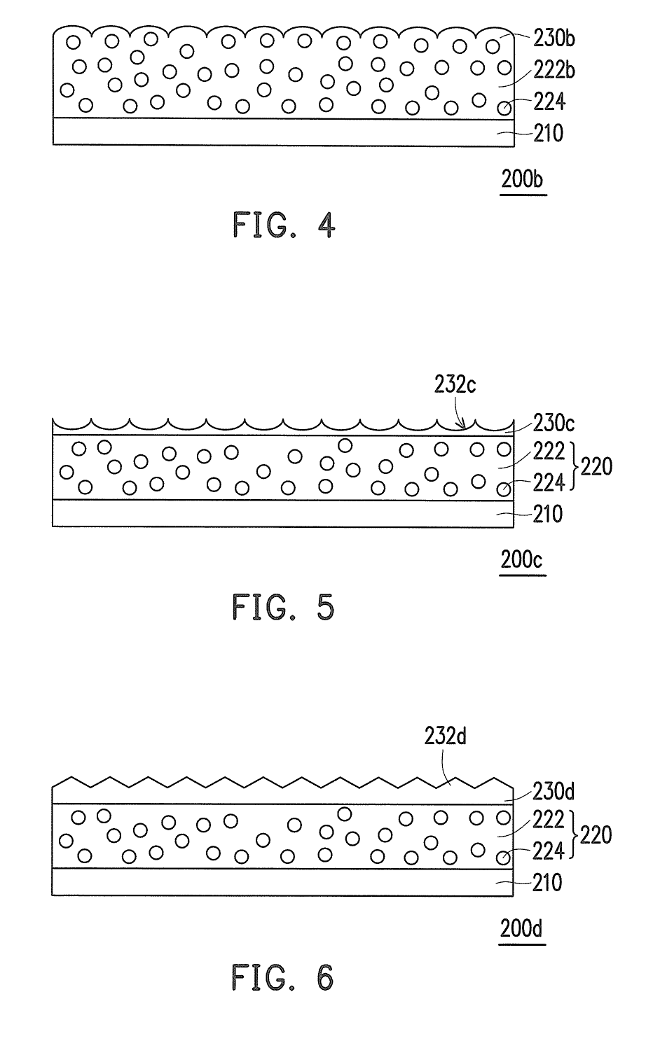

FIG. 4 is a schematic cross-sectional view illustrating a wavelength conversion module according to yet another embodiment of the invention. With reference to FIG. 4, the wavelength conversion module 200b provided in the embodiment is similar to the wavelength conversion module 200 depicted in FIG. 1C, and the difference therebetween is described below. In FIG. 1C, the microstructure layer 230 and the transparent base 222 are individually formed, while the microstructure layer 230b and the transparent base 222b in the wavelength conversion module 200b are integrally formed. Besides, the wavelength conversion material 224 may be doped in both the microstructure layer 230b and the transparent base 222b.

FIG. 5 is a schematic cross-sectional view illustrating a wavelength conversion module according to yet another embodiment of the invention. With reference to FIG. 5, the wavelength conversion module 200c provided in the embodiment is similar to the wavelength conversion module 200 depicted in FIG. 1C, and the difference therebetween is described below. In the wavelength conversion module 200c described in the embodiment, the microstructures 232c of the microstructure layer 230c have arc-shaped concave surfaces.

FIG. 6 is a schematic cross-sectional view illustrating a wavelength conversion module according to yet another embodiment of the invention. With reference to FIG. 6, the wavelength conversion module 200d provided in the embodiment is similar to the wavelength conversion module 200 depicted in FIG. 1C, and the difference therebetween is described below. In the wavelength conversion module 200d described in the embodiment, the microstructures 232d of the microstructure layer 230d are pyramidal or tetrahedron.

To sum up, the microstructure layer in the wavelength conversion module and the illumination system described herein is located on the strip-shaped wavelength conversion layer, and the microstructures are arranged on the surface of the microstructure layer in a close-packing manner. Therefore, beams coming from the strip-shaped wavelength conversion layer are less likely to be totally reflected and more likely to be emitted from the wavelength conversion module, and the divergence angle at which the beams emitted from the wavelength conversion module may be reduced by the microstructures. Thereby, the wavelength conversion module is able to accomplish favorable light-collecting effects and have improved light extraction efficiency, and the illumination system having the wavelength conversion module can have satisfactory light utilization efficiency.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Apparently, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A wavelength conversion module comprising:
a reflective substrate;
a strip-shaped wavelength conversion layer located on the reflective substrate, the strip-shaped wavelength conversion layer comprising a transparent base and a wavelength conversion material doped in the transparent base; and
a microstructure layer located on the strip-shaped wavelength conversion layer, the microstructure layer comprising a plurality of microstructures arranged on a surface of the microstructure layer in a close-packing manner, the wavelength conversion module satisfying n2−0.3≦n1≦n2+0.3, wherein n1 is a refractive index of the transparent base, and n2 is a refractive index of the microstructure layer.

2. The wavelength conversion module as recited in claim 1, wherein each of the microstructures satisfies P/4≦h≦P/2, h is a height of the each of the microstructures in a direction perpendicular to the reflective substrate, and P is a pitch of the each of the microstructures in a direction parallel to the reflective substrate.

3. The wavelength conversion module as recited in claim 1, wherein the strip-shaped wavelength conversion layer is a ring-shaped wavelength conversion layer.

4. The wavelength conversion module as recited in claim 3, further comprising a reflective cup located on the reflective substrate, wherein the ring-shaped wavelength conversion layer is located in the reflective cup.

5. The wavelength conversion module as recited in claim 4, wherein the reflective cup comprises:
a first ring-shaped reflective structure located on an inner side of the ring-shaped wavelength conversion layer; and
a second ring-shaped reflective structure located on an outer side of the ring-shaped wavelength conversion layer.

6. The wavelength conversion module as recited in claim 5, wherein the first ring-shaped reflective structure has a first reflective surface tilting with respect to the reflective substrate and facing the outer side of the ring-shaped wavelength conversion layer, and the second ring-shaped reflective structure has a second reflective surface tilting with respect to the reflective substrate and facing the inner side of the ring-shaped wavelength conversion layer.

7. The wavelength conversion module as recited in claim 1, wherein the wavelength conversion material is a fluorescent material.

8. The wavelength conversion module as recited in claim 1, further comprising an actuator configured to rotate the reflective substrate.

9. The wavelength conversion module as recited in claim 1, wherein the microstructure layer and the transparent base are integrally formed.

10. The wavelength conversion module as recited in claim 1, wherein the microstructures are located on a surface of the microstructure layer facing away from the strip-shaped wavelength conversion layer, and the microstructures comprise partially-spherical shape, arc-shaped concave surfaces, pyramidal, tetrahedron, or a combination thereof.

11. An illumination system comprising:
a wavelength conversion module comprising:
a reflective substrate;
a strip-shaped wavelength conversion layer located on the reflective substrate, the strip-shaped wavelength conversion layer comprising a transparent base and a wavelength conversion material doped in the transparent base; and
a microstructure layer located on the strip-shaped wavelength conversion layer, the microstructure layer comprising a plurality of microstructures arranged on a surface of the microstructure layer in a close-packing manner, the wavelength conversion module satisfying n2−0.3≦n1≦n2+0.3, wherein n1 is a refractive index of the transparent base, and n2 is a refractive index of the microstructure layer; and
an excitation light source configured to emit an excitation beam, wherein the excitation beam coming from the excitation light source is transmitted to the strip-shaped wavelength conversion layer through the microstructure layer.

12. The illumination system as recited in claim 11, wherein each of the microstructures satisfies P/4≦h≦P/2, h is a height of the each of the microstructures in a direction perpendicular to the reflective substrate, and P is a pitch of the each of the microstructures in a direction parallel to the reflective substrate.

13. The illumination system as recited in claim 11, wherein the strip-shaped wavelength conversion layer is a ring-shaped wavelength conversion layer.

14. The illumination system as recited in claim 13, wherein the wavelength conversion module further includes a reflective cup located on the reflective substrate, and the ring-shaped wavelength conversion layer is located in the reflective cup.

15. The illumination system as recited in claim 14, wherein the reflective cup comprises:
a first ring-shaped reflective structure located on an inner side of the ring-shaped wavelength conversion layer; and
a second ring-shaped reflective structure located on an outer side of the ring-shaped wavelength conversion layer.

16. The illumination system as recited in claim 15, wherein the first ring-shaped reflective structure has a first reflective surface tilting with respect to the reflective substrate and facing the outer side of the ring-shaped wavelength conversion layer, and the second ring-shaped reflective structure has a second reflective surface tilting with respect to the reflective substrate and facing the inner side of the ring-shaped wavelength conversion layer.

17. The illumination system as recited in claim 11, wherein the wavelength conversion material is a fluorescent material.

18. The illumination system as recited in claim 11, wherein the wavelength conversion module further includes an actuator configured to rotate the reflective substrate, and when the reflective substrate is rotated, different regions on the strip-shaped wavelength conversion layer enter an irradiation range of the excitation beam at different times.

19. The illumination system as recited in claim 11, wherein the microstructure layer and the transparent base are integrally formed.

20. The illumination system as recited in claim 11, wherein the excitation light source is a laser light source.
